(19) United States
(12) Patent Application Publication
(10) Pub. No.: US 2025/0361956 A1
(43) Pub. Date: Nov. 27, 2025

(54) PIPE FOR A CRYOGENIC FLUID, PIPE ASSEMBLY, AND AEROSPACE SYSTEM WITH PIPE

(71) Applicant: ArianeGroup GmbH, TAUFIRCHEN (DE)

(72) Inventors: Patrick GERDING, BREMEN (DE); Michael QUATMANN, BREMEN (DE); Bastian DANNEMANN, BREMEN (DE)

(21) Appl. No.: 19/215,582

(22) Filed: May 22, 2025

(30) Foreign Application Priority Data
May 24, 2024 (EP) 24177989.1

(51) Int. Cl. F16L 9/12; F16L 23/036

(52) U.S. Cl. CPC F16L 9/121; F16L 23/036

(57) ABSTRACT

A pipe for conducting a cryogenic fluid. The pipe includes a rigid outer tube at least partially made of a fiber-reinforced polymer, a gas-proof inner tube running within the outer tube, an insulation layer arranged between the inner tube and the outer tube, and at least one flange formed at a respective end of the inner tube. The at least one flange connects the inner tube with the outer tube. Also a pipe assembly with at least two such pipes which are connected or configured to be connected at their respective flanges, and an aerospace system with at least one such pipe.

### CROSS-REFERENCES TO RELATED APPLICATIONS

This application claims the benefit of European Patent Application Number 24177989.1 filed on May 24, 2024, the entire disclosure of which is incorporated herein by way of reference.

### FIELD OF THE INVENTION

In aerospace systems, liquids and gases are typically transported, e.g., from a respective reservoir to a respective point of use, by using rigid or flexible lines comprising one or various pipes. Conventionally, these pipelines form part of the so-called “secondary” structure, which is not used to support structural loads during operation, but is needed to fulfil certain secondary functions. The pipes are usually made of a metal alloy and are attached to the adjacent load-bearing, so-called “primary” structure by means of brackets.

### BACKGROUND OF THE INVENTION

New systems such as the FLINT system (Fluid Line Integrated Thrustframe) achieve mass savings by consistently integrating the secondary structure into the primary structure, such that existing mass is used to accomplish several functions. In particular, by using intermediate struts, rigid pipes may be combined into trusses and thereby be used as structural elements for load transfer.

However, if cryogenic media, such as liquid hydrogen, are transported, a significant cooling of the pipes occurs during operation. This change in temperature between the state of assembling on the one hand and operating states on the other hand leads to large, material-dependent changes in length. In order to still securely connect the pipes to the primary structure of the respective aircraft or spacecraft, compensators are traditionally used to compensate for the deformations between respective attachment points.

Furthermore, the use of cryogenic fluids requires thermal insulation of the lines in order to limit heat flow into the media which otherwise might be mission critical due to bubble formation resulting from excessive heat input. There are various options for insulation, such as using double-walled pipes with evacuated spaces (vacuum insulation), or utilizing insulation foams which may be sprayed onto the pipe, attached to the outside as half-shells, or wrapped about a tube in the form of flexible mats. As a further possibility, multi-layer insulation (MLI) films may also be used for insulation of the tubes. Insulating the respective fastening points, however, is difficult because a conductive connection is necessarily created between the holder and the tube. Therefore, the maximum number of attachment points on a pipeline is limited by the respective maximum allowable heat flow.

The above-mentioned dual use of the pipes by integration thereof into the primary system is adverse to the utilization of structural elements to compensate for the changes in length. For the structural use of pipes, a high stiffness and stability is required, which is opposite to compensation functions. In addition, said dual use entails an increased number of connection points and, thereby, an augmented heat flow into the pipes. The design of a structural integrated system architecture with classical pipes made from materials with significant thermal expansion is therefore a challenging task.

### SUMMARY OF THE INVENTION

It is an object of the present invention to provide an improved pipe and pipe assembly for conduction of a cryogenic fluid. It is a further object of the present invention to provide an improved aerospace system employing cryogenic fluid.

The object may be achieved by a pipe according to one or more embodiments described herein, by a pipe assembly according to one or more embodiments described herein, and by an aerospace system according to one or more embodiments described herein.

A pipe according to the present invention is devised to conduct a cryogenic fluid such as liquid hydrogen. The pipe comprises a rigid outer tube at least partially made of a fiber-reinforced polymer; the reinforcing fibers may in particular comprise carbon fibers and/or glass fibers. The pipe further comprises a gas-proof inner tube running within the outer tube with an (thermal) insulation layer in-between. The (preferably passive) insulation layer may in particular comprise a rigid foam and/or a multilayer insulation, for instance. At at least one end of the inner tube, a (respective) flange is formed which connects the inner tube with the outer tube.

Due to its inventive construction, the pipe according to the present invention facilitates a weight-saving utilization as a part of a primary structure of a respective system, in particular of an aerospace system. Therein, the outer tube serves to transfer the majority of structural loads, and the inner tube is configured to conduct the cryogenic fluid and to ensure impermeability to gas. As the insulation layer is inside the outer tube, its insulating properties are affected, if at all, at most insignificantly by ambient gases such as helium. In particular, the pipe is thermally stabilized.

Moreover, as a change of temperature of the outer tube during utilization of the pipe (i.e., when a flow of a cryogenic fluid is piped through) is efficiently reduced by the insulation layer, the outer tube can be mounted and/or combined with further structures (e.g., to at least one secondary structure) by fixation means, which may be attached to the outer tube without noteworthy impact to a heat flow into the conducted fluid. Indeed, according to advantageous embodiments, the pipe comprises one or various fixation means for combining the pipe with a further structure. The fixation means may respectively be fastened to or be integrally (monolithically) shaped with the outer tube.

The pipe may in particular be configured to be mounted in an aerospace system such as a launcher or a launcher stage.

The inner tube may preferably have a coefficient of thermal expansion, measured between 20° C. and 90° C., which is at most 2.5×10⁻⁶ K⁻¹ or at most 2×10⁻⁶ K⁻¹. It may be at least partially made of a metal alloy, such as a ferrous alloy, in particular a nickel-iron alloy (such as FeNi36), or of a composite material such as a fiber-reinforced plastic (wherein the reinforcing fibers may in particular comprise carbon fibers). Thereby, changes in length of the inner tube are minimized, i.e., no large structural shrinkage is induced, such that compensators conventionally adjusting such changes are unnecessary. A (mean) wall thickness of the inner tube may preferably be at most 8 mm or at most 5 mm, for instance.

A laminate structure of the fiber-reinforced polymer of the outer tube may be different in a longitudinal center than in at least one of its ends connected to the at least one (respective) flange. Thereby, the center region can be adapted to requirements regarding the strength of the outer tube and/or an efficient fabrication thereof, while nevertheless a particularly low coefficient of thermal expansion can be created in the region where the outer tube contacts the flange and where therefore a cooling may occur when the cryogenic fluid is conducted through the pipe. As a consequence, a stiff mounting of the pipe and, therefore, a load-bearing function thereof is improved.

To facilitate a connection with a further pipe, one or various through holes and/or a thread is/are preferably arranged in the flange.

The at least one flange may be integrally shaped with the inner tube. Alternatively, it may be materially connected to the inner tube (such as by gluing or welding) and/or it may be tied thereto in a form-fit connection (such as by screwing). Additionally or alternatively, the at least one flange may be materially connected (for example, glued) to the outer tube and/or tied thereto in a form-fit connection. A material of the at least one flange and a material of the inner tube preferably at least partially coincide. These embodiments facilitate a particularly convenient fabrication of the pipe. To improve its connection with the flange, the outer tube may have a thickening in its material at one or both of its ends.

According to advantageous embodiments, the at least one flange comprises a segment (further referred to herein as “bracket portion”) which embraces an edge margin of the insulation layer. Thereby, a durability of the layered arrangement and, thereby, of the pipe is improved. Preferably, a circumferential channel is arranged between the bracket segment and a flat contact segment of the at least one flange, which contact segment is configured to be connected to a further pipe (in particular, to a flange thereof). Such channel advantageously provides access to the contact segment and thereby simplifies the connection with another pipe, e.g. by inserting bolts in respective through holes and fastening them with nuts. To further improve a durability of the pipe, the outer tube may preferably at least partially cover the bracket segment.

According to advantageous embodiments, one or various grooves adapted to receive at least a segment of a respective seal ring are formed in the at least one flange.

The pipe according to the present invention may preferably comprise one or various insulation shell/s which is/are arranged on or configured to be arranged on the at least one flange when this is connected to another pipe, in particular, to a flange thereof. Such shell even more reduces a heat flow, from an environment into the pipe, through the connection area of the pipes.

A pipe assembly according to the present invention comprises at least two pipes according to (the same or different embodiment(s) of) the present invention. The pipes are connected or configured to be connected to each other at a respective flange thereof.

An aerospace system according to the present invention comprises at least one pipe according to an embodiment of the present invention. Therein, the at least one pipe forms part of a primary structure of the aerospace system.

The aerospace system may in particular be a launcher or a stage of a multistage launcher. It may comprise at least one engine which is configured to be driven with a cryogenic propellant such as liquid hydrogen. Therein, the at least one pipe may be configured to conduct the cryogenic propellant to the engine.

### BRIEF DESCRIPTION OF THE PREFERRED EMBODIMENTS

In what follows, preferred embodiments of the present invention are explained with respect to the accompanying drawings. As is to be understood, the various elements and components are depicted as examples only, may be facultative and/or combined in a manner different than depicted. Reference signs for related elements are used comprehensively and not necessarily defined again for each figure.

Shown is schematically:

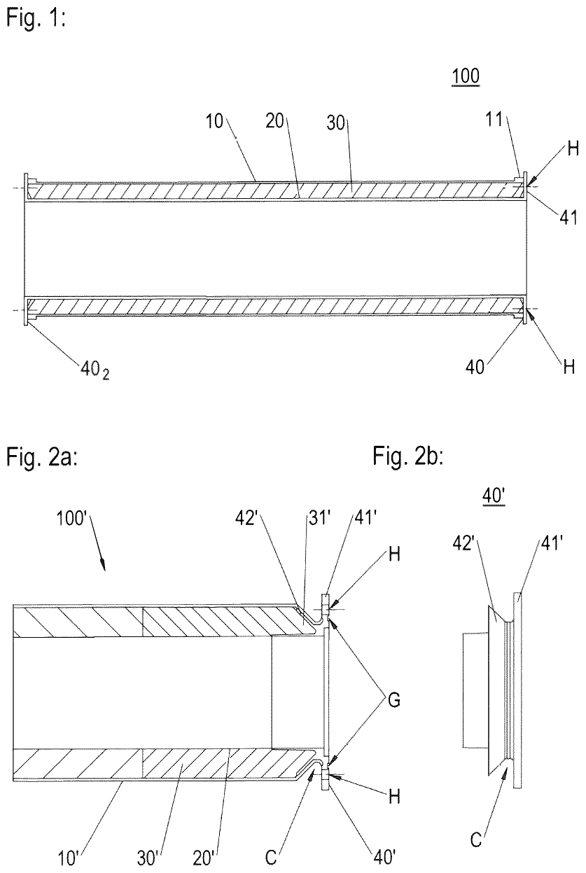

FIG. 1 is a first exemplary embodiment of a pipe according to the present invention in a longitudinal section;

FIG. 2a is an end segment of a second exemplary embodiment of a pipe according to the present invention in a longitudinal section;

FIG. 2b is a flange of the pipe of FIG. 2a in a side view;

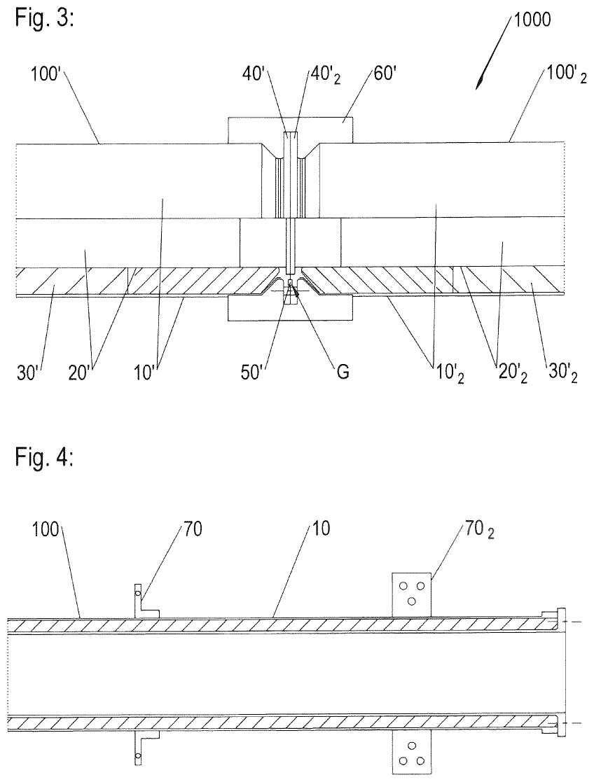

FIG. 3 is a pipe assembly with two pipes of the embodiment illustrated in FIG. 2a with an insulation shell arranged on the abutting flanges; and

FIG. 4 is a pipe as that shown in FIG. 1 further comprising fixation means fastened to the outer tube.

### DETAILED DESCRIPTION OF THE PREFERRED EMBODIMENTS

FIG. 1 illustrates a pipe 100 according to a first exemplary embodiment of the present invention in a longitudinal section. The pipe 100 comprises a rigid (thus, stiff) outer tube 10 which is made of a fiber reinforced polymer (such as a carbon fiber reinforced polymer).

The pipe 100 further comprises a gas-proof inner tube 20 running within the outer tube 10, with an insulation layer 30 in-between. The inner tube 20 may in particular be at least partially made of a metal alloy, such as a ferrous alloy, in particular a nickel-iron alloy such as FeNi36, or of a composite material.

The (preferably passive) insulation layer 30 may advantageously be at least partially made of a hardened (thus rigid) foam.

At both of its ends, a respective flange 40, 40₂ comprised by the pipe 100 connects the inner tube 20 with the outer tube 10. Both flanges 40, 40₂ are equally shaped; the respective details thereof are indicated, in FIG. 1, with respect to flange 40 comprising a contact segment 41 configured to be connected to a further pipe (not shown in FIG. 1), in particular to a corresponding flange thereof, by bolts (not shown) running through holes H in the contact segment 41, as indicated by respective dashed lines.

In the exemplary embodiment shown in FIG. 1, the respective contact segment 41 of each flange 40, 40₂ is formed integrally (thus, monolithically) with the inner tube; according to alternative embodiments, the respective flange might be materially connected (e.g., welded or glued) and/or positively fit (i.e., tied in a form-fit connection) to the inner tube 20, such as by being screwed to the inner tube 20, for instance.

Moreover, the flanges 40, 40₂ of the pipe 100 depicted in FIG. 1 are materially connected (e.g., glued) to the outer tube 10 at a thickened end segment 11 thereof, which thickening serves to improve the stability of the connection. According to alternative embodiments, the respective flange might be (additionally or alternatively) tied by a form-fit connection to the outer tube (not shown).

In FIG. 2a, an end segment of a pipe 100′ according to a further embodiment of the present invention is illustrated in a sectional view; a not shown opposite end of the pipe 100′ may preferably be designed equally to that depicted.

The pipe 100′ comprises a rigid (thus, stiff) outer tube 10′ which is made of a fiber reinforced polymer (e.g., a carbon fiber reinforced polymer), and a gas-proof inner tube 20′ running within the outer tube 10′, with an insulation layer 30′ in-between. The inner tube 20′ may in particular be at least partially made of a metal alloy, such as a ferrous alloy, in particular a nickel-iron alloy such as FeNi36, or of a composite material, in particular of a fiber-reinforced plastic, more specifically, a carbon fiber-reinforced plastic.

A flange 40′ connects the inner tube 20′ with the outer tube 10′; FIG. 2b illustrates the flange 40′ of the pipe 100′ alone in a side view.

As indicated in FIGS. 2a, 2b, the flange 40′ comprises a flat contact segment 41′ configured to be connected to a further pipe (not shown in said Figures), in particular to a corresponding flange thereof. An annular groove G formed in the contact segment 41′ serves to receive at least a portion of a seal ring (not shown) ensuring a gas-tight connection of the pipe 100′ with the further pipe.

The flange 40′ further comprises a bracket segment 42′ which embraces an edge margin 31′ of the insulation layer 30′. The bracket segment 42′ is separated from the contact segment 41′ by a circumferential channel C, and it is covered by an end segment of the outer tube 10′ extending into the channel C.

The thus at the end of the pipe 100′ established laminate of insulation layer 30′, bracket segment 42′, and outer tube 10′ ensures a particularly high durability of the pipe 100′. Moreover, the channel C provides access to through holes H in the contact segment 41′. As a consequence, the pipe 100′ can be easily connected, in its completed state, to the further pipe by bolts (not shown) inserted into the through holes H, as indicated in FIG. 2a by respective dashed lines.

FIG. 3 shows a segment of a pipe assembly 1000 according to the present invention, the pipe assembly 1000 comprising the pipe 100′ depicted in FIG. 2a which is connected with an equally shaped further pipe 100₂′. Therein, the upper area of FIG. 3 shows a lateral view of the connection, whereas the lower area of FIG. 3 provides a sectional view making visible the respective inner tubes 20′, 20₂′ and insulation layers 30′, 30₂′, as well as a seal ring 50′ inserted in the respective grooves G of the abutting flanges 40′, 40₂′.

Moreover, an insulation shell 60′ is arranged on the connected flanges 40′, 40₂′. Preferably, the insulation shell 60′ is combined with at least one further insulation shell (not shown) so as to entirely encompass the connected ends of the pipes 100′, 100₂′, thereby further reducing a heat flow from an environment into a fluid (not shown) running through the connected pipes 100′, 100₂′.

In FIG. 4, an end segment of the pipe 100 illustrated in FIG. 1 is depicted, wherein fixation means 70, 70₂, such as brackets or braces with fasteners, are fastened to the outer tube 10. The fixation means may serve to mount the pipe 100 in a respective structure (not shown) such as an aerospace system and/or to fasten a secondary structure to the pipe 100 (not shown).

Disclosed is a pipe 100, 100′, 100₂′ for conducting a cryogenic fluid. The pipe comprises a rigid outer tube 10, 10′, 10₂′ at least partially made of a fiber-reinforced polymer, a gas-proof inner tube 20, 20′, 202′ running within the outer tube 10, 10′, 102′, an insulation layer 30, 30′, 30₂′ arranged between the inner tube 20, 20′, 20₂′ and the outer tube 10, 10′, 10₂′, and at least one flange 40, 40′, 40₂′ formed at a respective end of the inner tube 20, 20′, 20₂′. The at least one flange 40, 40′, 40₂′ connects the inner tube 20, 20′, 20₂′ with the outer tube 10, 10′, 10₂′.

Further disclosed are a pipe assembly 1000 comprising at least two such pipes 100, 100′, 100₂′ which are connected or configured to be connected at a respective flange 40, 40′, 40₂′ thereof, and an aerospace system comprising at least one such pipe 100, 100′, 100₂′.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

10, 10′, 10₂′ outer tube
20, 20′, 20₂′ inner tube
30, 30′, 30₂′ insulation layer
31′ edge margin of insulation layer
40, 40′, 40₂′ flange
41, 41′ contact segment of flange
42′ bracket segment of flange
50′ seal ring
60′ insulation shell
100, 100′, 100₂′ pipe
1000 pipe assembly
C channel
G groove
H through hole

Claimed is:

1. A pipe for conducting a cryogenic fluid, the pipe comprising:
a rigid outer tube at least partially made of a fiber-reinforced polymer;
a gas-proof inner tube running within the rigid outer tube;
an insulation layer arranged between the gas-proof inner tube and the rigid outer tube; and
at least one flange formed at an end of the gas-proof inner tube, the at least one flange connecting the gas-proof inner tube with the rigid outer tube.

2. The pipe according to claim 1, wherein the at least one flange is integrally shaped with the gas-proof inner tube or materially connected to the gas-proof inner tube, tied thereto in a form-fit connection, or both, or
wherein the at least one flange is materially connected to the rigid outer tube, tied thereto in a form-fit connection, or both, or
both.

3. The pipe according to claim 1, wherein a material of the at least one flange and a material of the gas-proof inner tube at least partially coincide.

4. The pipe according to claim 1, wherein the gas-proof inner tube has a wall thickness of at most 8 mm, or
wherein the gas-proof inner tube has a coefficient of thermal expansion, measured between 20° C. and 90° C. which is at most 2.5×10⁻⁶ K⁻¹, or
wherein the gas-proof inner tube is at least partially made of a metal alloy or of a composite material, or
any combination thereof.

5. The pipe according to claim 1, wherein the at least one flange comprises a bracket segment embracing an edge of the insulation layer.

6. The pipe according to claim 5, wherein the bracket segment is separated, by a circumferential channel, from a flat contact segment of the at least one flange, the flat contact segment configured to be connected to a second pipe.

7. The pipe according to claim 5, wherein the rigid outer tube covers at least a portion of the bracket segment.

8. The pipe according to claim 1, wherein the insulation layer at least partially comprises a rigid foam.

9. The pipe according to claim 1, wherein at least one through hole, or at least one thread, or both are formed in the at least one flange for connection thereof with a second pipe.

10. The pipe according to claim 1, wherein one or more grooves are formed in the at least one flange, the one or more grooves configured to receive at least a portion of a seal ring.

11. The pipe according to claim 1, further comprising:
one or more insulation shells arranged on or configured to be arranged on the at least one flange when the at least one flange is connected to a second pipe.

12. The pipe according to claim 1, further comprising:
one or more fixation means for joining the pipe to a structure, the one or more fixation means respectively fastened to or integrally shaped with the rigid outer tube.

13. A pipe assembly comprising:
at least two pipes according to claim 1 which are connected or configured to be connected at respective at least one flanges.

14. An aerospace system comprising:
at least one pipe according to claim 1, the at least one pipe forming part of a primary structure of the aerospace system.

15. The aerospace system according to claim 14, wherein the aerospace system is a launcher or a stage of a multistage launcher and comprises at least one engine configured to be driven with a cryogenic propellant supplied through the at least one pipe.
